(19) United States
(12) Patent Application Publication
(10) Pub. No.: US 2015/0357946 A1
(43) Pub. Date: Dec. 10, 2015

(54) FULLY INTEGRATED MEDIUM VOLTAGE INPUT LOW VOLTAGE OUTPUT VARIABLE FREQUENCY DRIVE SYSTEM

(71) Applicant: EATON CORPORATION, Cleveland, OH (US)

(72) Inventors: THOMAS ARTHUR FARR, Candler, NC (US); John David Maurin, JR., Arden, NC (US); James Alan Yoho, Cumming, GA (US)

(73) Assignee: EATON CORPORATION, Cleveland, OH (US)

(21) Appl. No.: 14/299,597

(22) Filed: Jun. 9, 2014

(51) Int. Cl. H02P 6/08

(52) U.S. Cl. CPC H02P 6/08

(57) ABSTRACT

A motor drive system includes a step down phase shifting isolation transformer structured to receive medium voltage AC power from an AC bus and convert the medium voltage AC power to tow voltage AC power, a converter structured to receive the low voltage AC power and convert the low voltage AC power to DC power and output the DC power to a DC bus, and a tow voltage inverter structured to receive the DC power from the DC bus and convert the DC power to a second low voltage AC power.

### BACKGROUND

1. Field

The disclosed concept pertains generally to motor control drives, and, more particularly, to a fully integrated drive system that is able to take a medium voltage input and provide a low voltage output to drive a motor.

2. Background Information

There are numerous settings wherein motors are employed to drive heavy machinery. For example, multiple high horsepower electric motors are used in a pumping system, such as, without limitation, a water pumping system. As is known in the art, in such settings, there are a number of devices that can be used to control the motors. In particular, contactors, soft starters, and variable frequency drives (VFDs) (also referred to as adjustable frequency drives or AFDs) are different types of devices that can be used to control a motor in such a setting.

A contactor simply connects the motor directly across the AC line. A motor connected to the AC line will accelerate very quickly to full speed and draw a large amount of current during acceleration. Thus, use of a contactor only to control a motor has many drawbacks, and in many industrial settings will not be permitted by the electric utility.

A soft starter is a device used to slowly ramp up a motor to full speed, and/or slowly ramp down the motor to a stop. Reducing both current draw and the mechanical strain on the system are big advantages of using a soft starter in place of a contactor. Soft starters are more common on larger horsepower systems.

A VFD is a solid state electronic power converting device used for controlling the rotational speed of an alternating current (AC) electrical motor by controlling the frequency of the electrical power supplied to the motor. Typically, a VFD first converts an AC input power to a DC intermediate power using a rectifier circuit. The DC intermediate power is then converted to a quasi-sinusoidal AC power using an inverter switching circuit. A VFD not only has the ramping ability of a soft starter, but also allows the speed to be varied while at the same time offering more flexibility and features.

Many facilities have the need for both medium voltage and low voltage VFDs. There are currently, however, no devices that provide low voltage VFD functionality in a configuration that can be readily connected to a common medium voltage bus with medium voltage drives and/or other medium voltage control products.

### SUMMARY

In one embodiment, a motor drive system is provided that includes a step down phase shifting isolation transformer structured to receive medium voltage AC power from an AC bus and convert the medium voltage AC power to low voltage AC power, a converter structured to receive the low voltage AC power and convert the low voltage AC power to DC power and output the DC power to a DC bus, and a low voltage inverter structured to receive the DC power from the DC bus and convert the DC power to a second low voltage AC power.

In another embodiment, a method of driving a motor is provided. The method includes steps of receiving medium voltage AC power in a housing coupled to a medium voltage AC bus, phase shifting and stepping down the medium voltage AC power to create low voltage AC power within the housing, converting the low voltage AC power to DC power within the housing, inverting the DC power to the second low voltage AC power within the housing, and using the second low voltage AC power to drive the motor.

In another embodiment, the system can be an integral component of a motor control center interconnected with a common bussed assembly at Medium Voltage

Levels to distribute power to various adjacent motor and other loads at voltages from line voltage to other various voltage levels to control motors and other electrical loads.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of a medium voltage input/low voltage output variable frequency drive according to an exemplary embodiment of the present invention;

FIGS. 2A and 2B are a schematic diagram showing the transformer, converter, DC bus, low voltage inverter, and output filter of the variable frequency drive of FIG. 1 according to one particular, non-limiting exemplary embodiment;

FIGS. 3 and 4 are schematic diagrams of a motor control center according to one particular implementation that employs the concepts of the present invention.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the term “number” shall mean one or an integer greater than one (i.e., a plurality).

As employed herein, the statement that two or more parts are “coupled” together shall mean that the parts are joined together either directly or joined through one or more intermediate parts.

As employed herein, the terms “module”, “component” and/or “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As employed herein, the term “low voltage” shall mean 0V-999V.

As employed herein, the term “medium voltage” shall mean 1000V-15,000V.

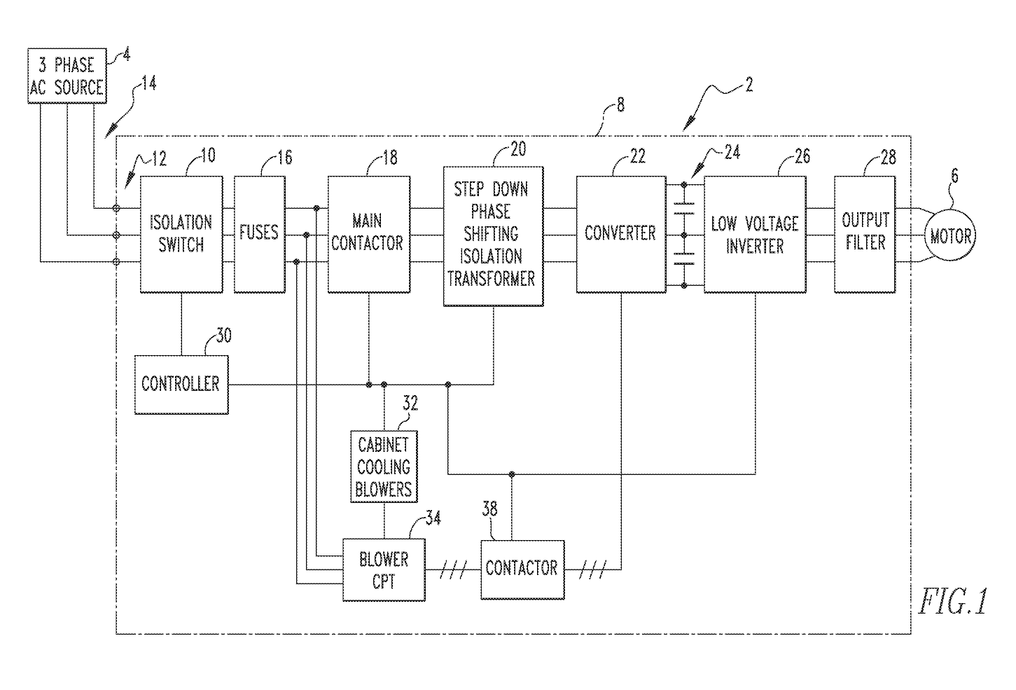

FIG. 1 is a schematic diagram of a medium voltage input/low voltage output variable frequency drive 2 according to an exemplary embodiment of the present invention. Variable frequency drive 2 is shown in FIG. 1 as being provided between a three phase AC source 4, which may be the utility grid, and a three phase motor 6. In the exemplary embodiment, variable frequency drive 2 includes a number of components that are provided within a single housing or package 8 such that variable frequency drive, as shown in FIG. 1 has three inputs and three outputs.

Variable frequency drive 2 includes a three phase isolation switch 10 coupled to an integrated AC bus 12. AC bus 12 is connected to a common medium voltage AC bus 14 that may be also coupled to one or more medium voltage electronic devices, such as one or more medium voltage drives and/or one or more medium voltage control products. Isolation switch 10 is coupled to a number of fuses 16 which in turn are coupled to a three phase main contactor 18. As described in more detail below, isolation switch 10, fuses 16, and main contactor 18 provide isolation and main disconnect functionality for variable frequency Drive 2. The output of main contactor 18 is coupled to the primary winding of a step down, phase shifting isolation transformer 20. Transformer 20 is structured to step in input voltage down from a medium voltage range to a low voltage range.

The secondary windings of transformer 20 are coupled to the inputs of a converter 22 that is structured to convert and AC input voltage to a DC output voltage. In the exemplary embodiment, converter 22 is a rectifier and may include, for example, and without limitation, a 24 pulse diode bridge rectifier, a 18 pulse diode bridge rectifier, or a 12 pulse diode bridge rectifier. The output of converter 22 is coupled to a DC bus 24, which in the exemplary embodiment is a series paralleled capacitive DC bus. Also coupled to DC bus 24 is a low voltage inverter 26 that is structured to convert a DC input voltage to a low voltage quasi-sinusoidal AC output voltage. Low voltage inverter 26 may be any type of suitable low voltage inverter, such as, without limitation, a multi-level inverter. The output of low voltage inverter 26 is provided to an optional output filter 28, which conditions the power received from low voltage inverter 26 and outputs a cleaner three-phase power output to motor 6.

Variable frequency drive 2 further includes a controller 30. Controller 30 may be any type of suitable processing or control unit, such as, without limitation, a microprocessor, a microcontroller, relay control or a programmable logic controller (PLC), that is structured and configured (e.g., via appropriate programming) to function as described herein. Controller 30 controls pre-charging of variable frequency drive 2, as described herein, operation of main contactor 18, operation of cabinet cooling blowers 32 (provided to cool the components of variable frequency drive 2), monitoring of low voltage inverter 26 and monitoring of resistive temperature devices (RTDs) of transformer 20 (to provide and over temperature trip when appropriate). In addition, as seen in FIG. 1, variable frequency drive 2 further includes a blower control power transformer (CPT) 34 which receives a power input from 3 phase AC source (at the output side of fuses 16) to power cabinet cooling blowers 32. Blower control power transformer 34 is coupled to a contactor 38 which, when closed, will feed power from blower control power transformer 34 to DC bus 24 through converter 22 during a pre-charging operation. The pre-charging operation will slowly charge up the capacitors of DC bus 24 at start up to prevent a large inrush of current to DC bus 24.

In operation, when variable frequency drive 2 is to become operational to drive motor 6, controller 30 initiates the pre-charging system upon manual closing of isolation switch 10. Controller 30 closes contactor 38 so that power is provided to the pre-charge system. When low voltage inverter 26 is properly pre-charged, the control unit thereof sends a signal to controller 30. In response to that signal, which indicates that pre-charging is complete, controller 30 closes main contactor 18, which results in medium voltage AC power from medium voltage AC bus 14 being provided to the primary winding of transformer 20. Transformer 20 phase shifts that AC power and steps it down to a low voltage level. The low voltage AC power is provided to the input of converter 22. Converter 22 converts the low voltage AC power to DC voltage and outputs that DC voltage onto DC bus 24. The DC voltage from DC bus 24 is provided to low voltage inverter 26 which converts it to a quasi-sinusoidal low voltage AC output. That output is provided to output filter 28 which in turn outputs a conditioned low voltage AC power signal to motor 6.

Thus, variable frequency drive 2 provides in a fully integrated package a device that is able to be connected to a common medium voltage bus and provide low voltage VFD functionality for controlling a motor. This package includes the distributed MV bus assembly that provides input power to various adjacent structures. This provides one motor control center that connects multiple loads to be distributed at various voltage levels, all within one common bus assembled and integrated product.

In addition, in the exemplary embodiment shown in FIG. 1, converter 22 and DC bus 24 are shown as feeding a single low voltage inverter 26. Alternatively, multiple low voltage DC inverters may be fed by DC bus 24.

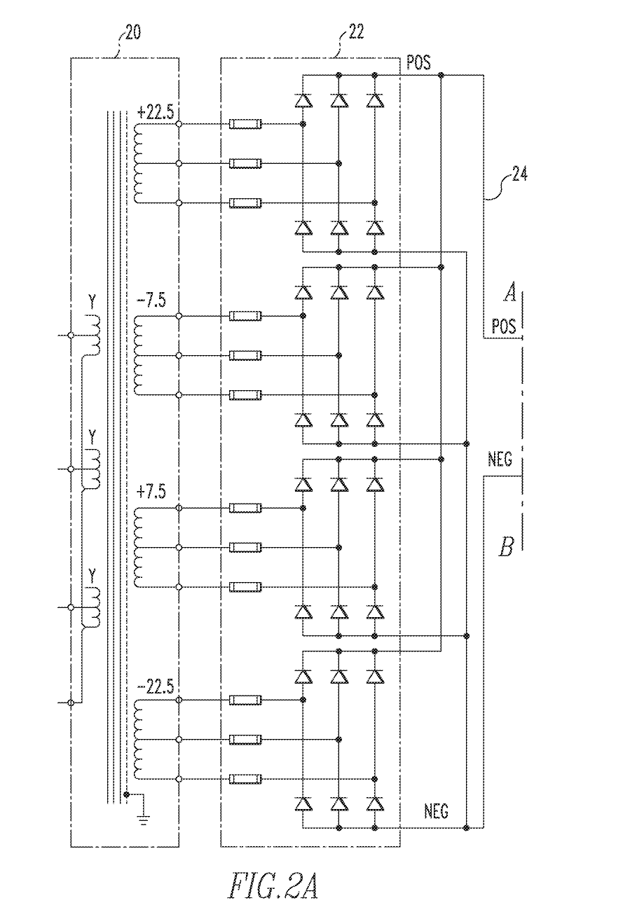

FIGS. 2A and 2B are a schematic diagram showing transformer 20, converter 22, DC bus 24, low voltage inverter 26, and output filter 28 according to one particular, non-limiting exemplary embodiment. As seen in FIGS. 2A and 2B, in this exemplary embodiment, transformer 20 is provided with 4 secondary windings. In addition, in this exemplary embodiment, converter 22 is a 24 pulse diode rectifier that includes 4 parallel connected DC bridges. Also in this embodiment, low voltage inverter 26 is a voltage source type inverter configuration and output filter 28 is a passive type output filter.

In one particular exemplary embodiment, medium voltage bus 14 is structured to carry 1,000V-15,000V and low voltage inverter is structured to output 230V-690V. It will be understood, however, that this is meant to be exemplary only, and that other medium voltage and/or low voltage ranges are contemplated within the scope of the present invention.

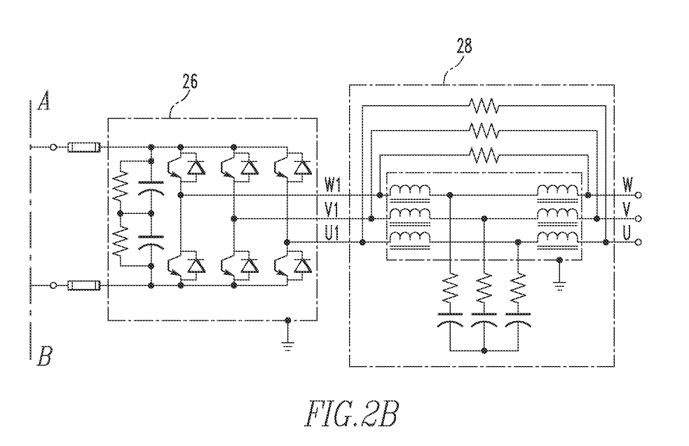

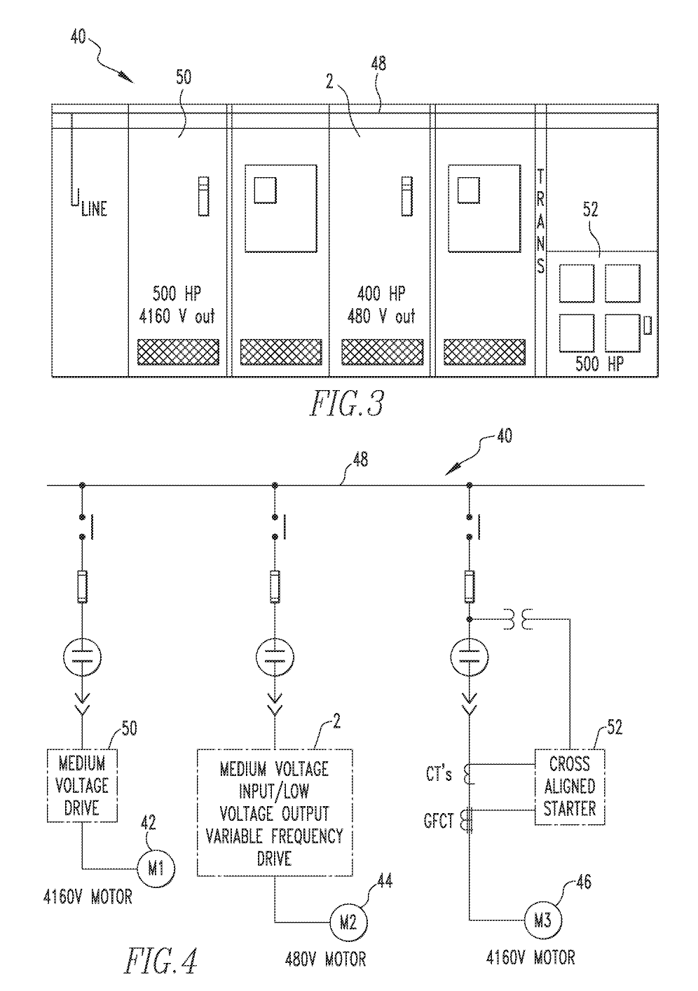

FIGS. 3 and 4 are schematic diagrams of a motor control center 40 according to one particular implementation that employs the concepts of the present invention. As seen in FIG. 4, motor control center 40 is configured to drive a medium voltage motor 42, a low voltage motor 44, and a medium voltage motor 46. Motor control center 40 includes a common medium voltage AC bus 48 that may be coupled to, for example and without limitation, a utility AC source. A conventional (i.e., medium voltage input to medium voltage output) medium voltage drive 50 is coupled to medium voltage AC bus 48 and is used to drive medium voltage motor 42, medium voltage input/low voltage output variable frequency drive 2 as described elsewhere herein is coupled to medium voltage AC bus 48 to drive low voltage motor 44, and a cross aligned starter 52 is coupled to medium voltage AC bus 48 to drive medium voltage motor 46. Thus, in this implementation, variable frequency drive 2 is an integral component of motor control center 40 with a common bussed assembly at medium voltage levels to distribute power to various adjacent motors 42, 44, 46 and/or other loads at voltages from line voltage to other various voltage levels.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A motor drive system, comprising:
a step down phase shifting isolation transformer structured to receive medium voltage AC power from an AC bus and convert the medium voltage AC power to low voltage AC power;
a converter structured to receive the low voltage AC power and convert the low voltage AC power to DC power and output the DC power to a DC bus; and
a low voltage inverter structured to receive the DC power from the DC bus and convert the DC power to a second low voltage AC power.

2. The motor drive system according to claim 1, further comprising an isolation switch and a main contactor provided between the step down phase shifting isolation transformer and the AC bus.

3. The motor drive system according to claim 2, further comprising a controller operatively coupled to the isolation switch and the main contactor, the controller being structured to control the isolation switch and the main contactor.

4. The motor drive system according to claim 3, further comprising a pre charging module coupled to the converter wherein the controller is structured to cause the pre-charging module to provide pre-charging power to the converter and in response to receipt of a signal from the low voltage inverter, cause the pre-charging module to stop providing the pre-charging power to the converter and close the main contactor so that the medium voltage AC power is provided to the step down phase shifting isolation transformer.

5. The motor drive system according to claim 4, wherein the pre-charging module includes a control power transformer coupled to an AC source and a contactor coupled to the control power transformer and the converter, the contactor being controlled by the controller.

6. The motor drive system according to claim 1, further comprising an output filter coupled to an output of the low voltage inverter.

7. The motor drive system according to claim 2, wherein the isolation switch, the main contactor, the step down phase shifting isolation transformer, the converter, and the low voltage inverter are provided within a single, fully integrated housing.

8. The motor drive system according to claim 7, further comprising a number of fuses provided between the isolation switch and the main contactor.

9. The motor drive system according to claim 1, wherein the converter comprises a multi-pulse diode bridge rectifier.

10. The motor drive system according to claim 9, wherein the multi-pulse diode bridge rectifier is a 24 pulse bridge rectifier.

11. A method of driving a motor, comprising:
receiving medium voltage AC power in a housing coupled to a medium voltage AC bus;
phase shifting and stepping down the medium voltage AC power to create low voltage AC power within the housing;
converting the low voltage AC power to DC power within the housing;
inverting the DC power to the second low voltage AC power within the housing; and
using the second low voltage AC power to drive the motor.

12. The method according to claim 11, wherein the converting is performed by a converter and wherein the converter is isolated from the medium voltage AC bus by a transformer that performs these phase shifting and stepping down.

13. The method according to claim 12, wherein prior to the phase shifting and stepping down, an isolation switch and a main contactor provided within the housing are closed.

14. The method according to claim 13, wherein the main contactor is closed in response to receiving a signal that a pre-charging operation performed on the converter has been completed.
